(19) United States
(12) Patent Application Publication
(10) Pub. No.: US 2025/0069039 A1
(43) Pub. Date: Feb. 27, 2025

(54) SYSTEM AND METHOD FOR EVALUATING CANDIDATES THROUGH ARTIFICIAL INTELLIGENCE (AI) MODELS

(71) Applicant: HCL Technologies Limited, New Delhi (IN)

(72) Inventors: VINEET SHARMA, Noida (IN); HIMANSHU TAGRA, Noida (IN); CHITARANJAN BEHERA, Noida (IN); MANAV MANCHANDA, Santa Clara, CA (US); PRABHAGARAN SAMBANDAM, Noida (IN)

(21) Appl. No.: 18/663,168

(22) Filed: May 14, 2024

(30) Foreign Application Priority Data
Aug. 22, 2023 (IN) 202311056328

(51) Int. Cl. G06Q 10/1053; G06V 10/40; G10L 15/02

(52) U.S. Cl. CPC G06Q 10/1053; G06V 10/40; G10L 15/02

(57) ABSTRACT

This disclosure relates to method and system for evaluating through the Artificial intelligence (AI) model. The method includes receiving input data comprising video data and audio data corresponding to an interview of a candidate. The method further includes extracting in near real-time a set of video and audio features from each of the plurality of frames of the video data using a first self-learning AI model and audio data using a second self-learning AI model. The method further includes comparing the set of video features and the set of audio features with predefined threshold values corresponding to the set of predefined parameters. The method further includes generating a score corresponding to each of the set of predefined parameters of the candidate using the first self-learning AI model and the second self-learning AI model.

### TECHNICAL FIELD

This disclosure relates generally to Artificial Intelligence (AI), and more particularly to method and system for evaluating candidates through AI models.

### BACKGROUND

Video communication is now widely used for instruction, communication, and evaluation in schools, universities, and businesses. One of the applications of video communication includes conducting online audio-video assessments and interviews by various organisations and institutes. Online video conferencing provides many benefits in terms of saving time, cost, resources, ease of remote working, and online assessment of the candidates.

On an average, any mid to large organization and institutes might be conducting hundreds (if not thousands) of evaluation calls per month. Evaluation of each candidate may require, on an average, 2-3 evaluators for evaluating different parameters. Arranging multiple interview rounds is tedious and labour-intensive. In certain cases, to avoid multiple rounds of evaluation of the same candidate, the organization or body may overlook critical, non-core evaluation parameters (such as soft skills).

Evaluators are among the most skilled members or the key decision makers in the organization, and their bandwidth for the evaluation is not only crucial and expensive, but also limited. This effects the scalability of such organizations and institutions.

Thus, the techniques in the present state of art fail to address the problem of automating candidate evaluation. There is, therefore, a need for robust and reliable techniques for automated candidate evaluation.

### SUMMARY

In one embodiment, a method for evaluating candidates through Artificial Intelligence (AI) models is disclosed. In one example, the method may include receiving input data including video data and audio data corresponding to an interview of a candidate. It may be noted that the video data may include a plurality of frames. The method may further include extracting in near real-time, a set of video features from each of the plurality of frames of the video data using a first self-learning AI model, and a set of audio features from the audio data using a second self-learning AI model. It may be noted that the set of video and the set of audio features may correspond to a set of predefined parameters. The method may further include comparing the set of video features and the set of audio features with self-adjusting threshold values corresponding to the set of predefined parameters. The method may further include generating a score corresponding to each of the set parameters of the candidate using the first self-learning AI model and the second self-learning AI model based on the comparison.

In one embodiment, a system for evaluating candidates through Artificial Intelligence (AI) models is disclosed. In one example, the system may include a processor and a computer-readable medium communicatively coupled to the processor. The computer-readable medium may store processor-executable instructions, which, on execution, may cause the processor to receive input data including video data and audio data corresponding to an interview of a candidate. It may be noted that the video data may include a plurality of frames. The processor-executable instructions, on execution, may further cause the processor to extract in near real-time, a set of video features from each of the plurality of frames of the video data using a first self-learning AI model, and a set of audio features from the audio data using a second self-learning AI model. It may be noted that the set of video features and the set of audio features may correspond to a set of predefined parameters. The processor-executable instructions, on execution, may further cause the processor to compare the set of video features and the set of audio features with self-adjusting threshold values corresponding to the set of predefined parameters. The processor-executable instructions, on execution, may further cause the processor to generate a score corresponding to each of the set of predefined parameters of the candidate using the first self-learning AI model and the second self-learning AI model based on the comparison.

In one embodiment, a non-transitory computer-readable medium storing computer-executable instructions for evaluating candidates through Artificial Intelligence (AI) models is disclosed. In one example, the stored instructions, when executed by a processor, may cause the processor to perform operations including receiving input data including video data and audio data corresponding to an interview of a candidate. It may be noted that the video data may include a plurality of frames. The operations may further include extracting in near real-time, a set of video features of the plurality of frames of the video data using a first self-learning AI model, and a set of audio features from the audio data using a second self-learning AI model. It may be noted that the set of video features and the set of audio features may correspond to a set of predefined parameters. The operations may further include comparing the set of video features and the set of audio features with self-adjusting threshold values corresponding to the set of predefined parameters. The operations may further include generating a score corresponding to each of the set of predefined parameters of the candidate using the first self-learning AI model and the second self-learning AI model based on the comparison.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for evaluating candidates through Artificial Intelligence (AI) models, in accordance with some embodiments of the present disclosure.

FIG. 2 illustrates a functional block diagram of a computing device for evaluating candidates through AI models, in accordance with some embodiments of the present disclosure.

FIG. 3 illustrates a flow diagram of an exemplary process for evaluating candidates through AI models, in accordance with some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

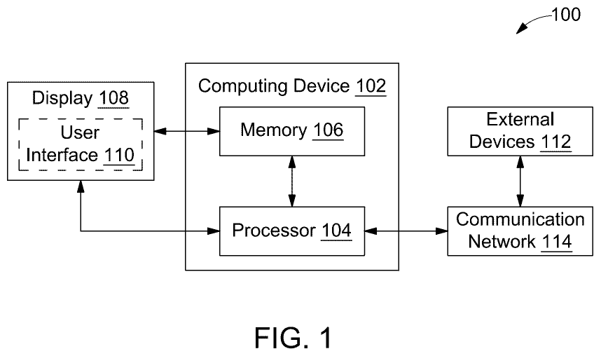

Referring now to FIG. 1, an exemplary system 100 for evaluating candidates through Artificial Intelligence (AI) models is illustrated, in accordance with some embodiments of the present disclosure. The system 100 may include a computing device 102 (for example, server, desktop, laptop, notebook, netbook, tablet, smartphone, mobile phone, or any other computing device), in accordance with some embodiments of the present disclosure. The computing device 102 may evaluate candidates through one or more AI models.

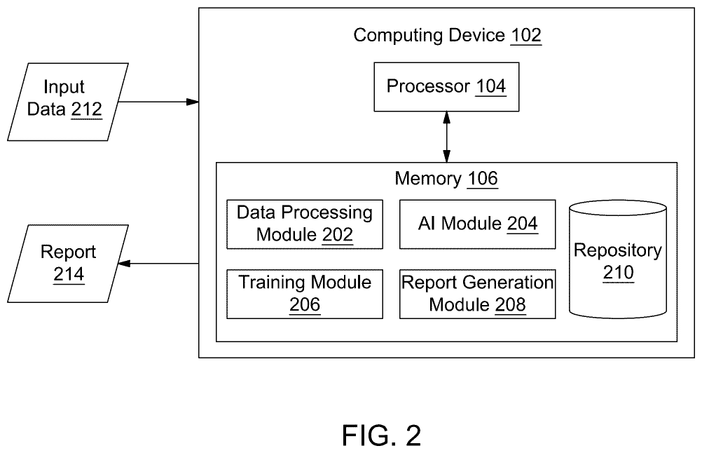

As will be described in greater detail in conjunction with FIGS. 2-4, the computing device 102 may receive input data including video data and audio data corresponding to an interview of a candidate. It may be noted that the video data may include a plurality of frames. The computing device 102 may extract in near real-time, a set of video features from each of the plurality of the video data using a first self-learning AI model and a set of audio features from the data using a second self-learning AI model. It may be noted that the set of video features and the set of audio features may correspond to a set of predefined parameters. The computing device 102 may further compare the set of video features and the set of audio features with self-adjusting threshold values corresponding to the set of predefined parameters. The computing device 102 may further generate a score corresponding to each of the set parameters of the candidate using the first self-learning AI model and the second self-learning AI model based on the comparison.

In some embodiments, the computing device 102 may include one or more processors 104 and a memory 106. Further, the memory 106 may store instructions that, when executed by the one or more processors 104, cause the one or more processors 104 to evaluate candidates through AI models, in accordance with aspects of the present disclosure. The memory 106 may also store various data (for example, video data, audio data, AI model data, training data, and the like) that may be captured, extracted, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram of the computing device 102 for evaluating candidates through AI models, in accordance with some embodiments of the present disclosure. The memory 106 of the computing device 102 may include a data processing module 202, an AI module 204, a training module 206, a report generation module 208, and a repository 210. The data processing module 202 may receive input data 212 corresponding to an interview of a candidate. The input data 212 may include video data and audio data corresponding to the interview. In an embodiment, the input data 212 may be received in real-time from one or more cameras. Alternatively, the input data 212 captured from the one or more cameras may be stored in the repository 210 and further processed at a later time instance.

Upon receiving the input data 212, the data processing module 202 may extract the video data and the audio data from the input data 212. In an embodiment, the repository 210 may further include a video repository and an audio repository. The video data may be stored in the video repository and the audio data may be stored in the audio repository.

The AI module 204 may retrieve the video data and the audio data from the repository 210. Alternatively, the AI module 204 may receive the extracted video data and the audio data from the data processing module 202 in real-time or near real-time. The AI module 204 may include a first self-learning AI model and a second self-learning AI model. In some embodiments, the second self-learning AI model may be a Natural Language Processing (NLP) model or a Large Language Model (LLM).

Each of the first and second self-learning AI models may include self-adjustable hyperparameters (i.e., weights). The self-adjustable hyperparameters may be adjusted by the first and second self-learning AI models during training stages or finetuning stages. In some embodiments, the self-adjustable hyperparameters may be adjusted based on real-time input data 212. To adjust the hyperparameters, the first and second self-learning AI models may determine new hyperparameters and replace old hyperparameters with the new hyperparameters.

Further, the AI module 204 may extract in near real-time, a set of video features from each of the plurality of frames of the video data using the first self-learning AI model. Additionally, the AI module 204 may extract in near real-time, a set of audio features from the audio data using the second self-learning AI model. It may be noted that the set of video features and the set of audio features may correspond to a set of predefined parameters. The set of video features and the set of audio features may further be used to evaluate the candidate. By way of an example, the set of predefined parameters may include, but may not be limited to, soft skill attributes, communication skill attributes, body language attributes, and knowledge attributes.

Further, the AI module 204 may compare the set of video features and the set of audio features with self-adjusting threshold values corresponding to the set of predefined parameters. The self-adjusting threshold values may change with time and training of the first and second self-learning AI models. Further, the AI module 204 may generate a score corresponding to each of the set of predefined parameters of the candidate using the first self-learning AI model and the second self-learning AI model based on the comparison. Candidate evaluation may be performed based on the score. The score may be a numerical value or a rating. In an embodiment, a weighted average score of the set of predefined parameters may be determined.

The training module 206 may train each of the first and second self-learning AI models of the AI module 204 using respective training datasets. The training datasets may be produced using the data stored in the repository 210. Alternatively, the training datasets may be obtained from external sources (for example, an external database). In some embodiments, the training module 206 may train each of the first and second self-learning AI models using the input data 212 received in real-time.

Further, the AI module 204 may send the score corresponding to each of the set of predefined parameters to the report generation module 208. The report generation module 208 may generate a report 214 for the candidate. The report 214 may include the set of predefined parameters and the score corresponding to each of the set of predefined parameters. The report may also include additional statistics and chart representations. The report 214 may be rendered on a Graphical User Interface (GUI) of a user device. The user device may be the computing device 102 or any other device which is communicably coupled with the computing device 102 through a communication network.

By way of an example, the computing device 102 may receive the input data 212 corresponding to three candidates, i.e., a first candidate, a second candidate, and a third candidate. The input data 212 may include a video recording (or a live stream video) of the interview of each of the three candidates. The data processing module 202 may extract video data and audio data from the input data 212 of each of the three candidates. Further, the AI module 204 may extract a set of video features and a set of audio features from the video data and the audio data, respectively, corresponding to a set of predefined parameters (for example, soft skill attributes, communication skill attributes, body language attributes, and knowledge attributes). For each of the three candidates, the set of video features and the set of audio features may then be compared with self-adjusting threshold values corresponding to the set of predefined parameters. For example, the threshold value for communication skill attributes at the time of evaluation is 20 and the threshold value for soft skill attributes at the time of evaluation is 30. Further, the AI module 204 may generate a score corresponding to each of the set of predefined parameters of the three candidates using the first and second self-learning AI models based on the comparison. For example, the scores corresponding to the communication skill attributes are 50, 60, and 70 for the first, second, and third candidates, respectively. The scores corresponding to the soft skill attributes are 40, 30, and 80 for the first, second, and third candidates, respectively. Further, for each of the three candidates, the report generation module 208 may generate the report 214 including the set of predefined parameters the score corresponding to each of the set of predefined parameters. In some embodiments, the report 214 may further include a recommendation (generated by the first self-learning AI model, the second self-learning AI model, or a third self-learning AI model). The report 214 may also include a natural language justification corresponding to the recommendation. In some embodiments, the computing device 102 may further be configured to select one or more candidates based on the corresponding scores.

It should be noted that all such aforementioned modules 202-210 may be represented as a single module or a combination of different modules. Further, as will be appreciated by those skilled in the art, each of the modules 202-210 may reside, in whole or in parts, on one device or multiple devices in communication with each other. In some embodiments, each of the modules 202-210 may be implemented as dedicated hardware circuit comprising custom application-specific integrated circuit (ASIC) or gate arrays, off-the-shelf semiconductors such as logic chips, transistors, or other discrete components. Each of the modules 202-210 may also be implemented in a programmable hardware device such as a field programmable gate array (FPGA), programmable array logic, programmable logic device, and so forth. Alternatively, each of the modules 202-210 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for evaluate candidates through AI models. For example, the exemplary system 100 and the associated computing device 102 may evaluate candidates through AI models by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

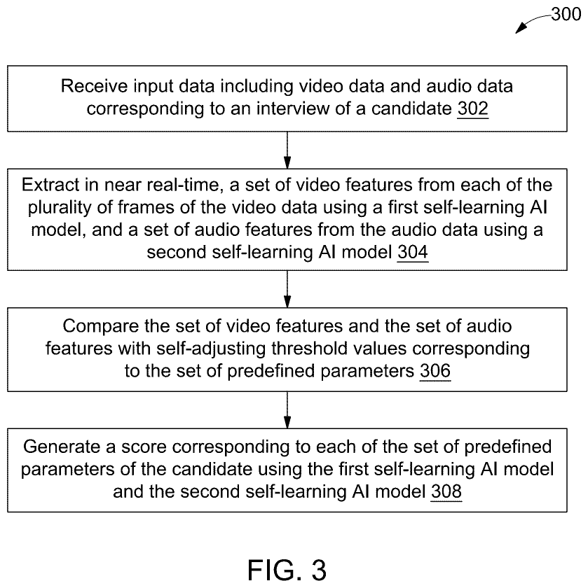

Referring now to FIG. 3, an exemplary process 300 for evaluating candidates through AI models is depicted via a flowchart, in accordance with some embodiments of the present disclosure. The process 300 may be implemented by the computing device 102 of the system 100.

At step 302, the data processing module 202 may receive input data (such as the input data 212) including video data and audio data corresponding to an interview of a candidate. It may be noted that the video data may include a plurality of frames. In some embodiments, the input data may be received in real-time from a camera. In some embodiments, the data processing module 202 may extract the video data and the audio data from the input data. Further, in some embodiments, the data processing module 202 may store the video data in a video repository (for example, the repository 210) and the audio data in an audio repository (for example, the repository 210).

At step 304, the data processing module 202 may extract in near real-time, a set of video features and audio features from each of the plurality of frames of video. In particular, the data processing module 202 may extract the set of video features from each of the plurality of frames of the video data using a first self-learning AI model. Further, the AI module 204 may extract a set of audio features from the audio data using a second self-learning AI model. It should be noted that the second self-learning AI model may be an NLP model or an LLM. Also, it should be noted that the set of video features and the set of audio features may correspond to a set of predefined parameters. By way of an example, the set of predefined parameters may include soft skill attributes, communication attributes, body language attributes, and knowledge attributes, and the like. Further, in some embodiments, the training module 206 may train the first self-learning AI model and the second self-learning AI model using the input data received in real time.

At step 306, the AI module 204 may compare the set of video features and the set of audio features with self-adjusting threshold values corresponding to the set of predefined parameters. At step 308, the AI module 204 may generate a score corresponding to each of the set parameters of the candidate using the first self-learning AI model and the second self-learning AI model based on the comparison. In some embodiments, the report generation module 208 may generate a report (such as the report 214) for the candidate. The report may include the set of predefined parameters and the score corresponding to each of the set of predefined parameters.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

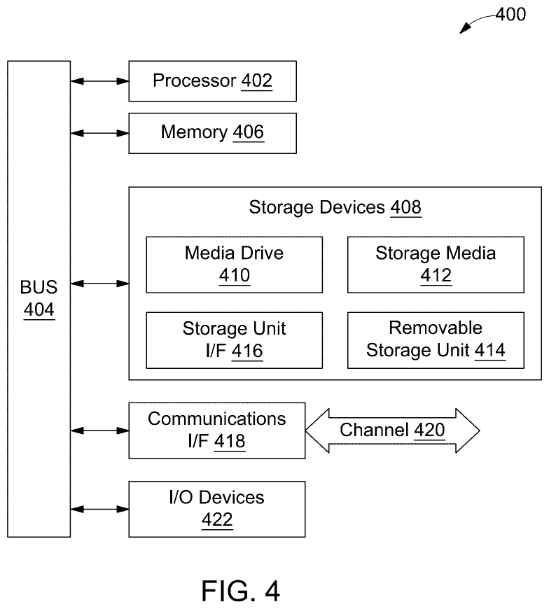

The disclosed methods and systems may be implemented on a conventional or a general-purpose computer system, such as a personal computer (PC) or server computer. Referring now to FIG. 4, an exemplary computing system 400 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 400 may represent, for example, a user device such as a desktop, a laptop, a mobile phone, personal entertainment device, DVR, and so on, or any other type of special or general-purpose computing device as may be desirable or appropriate for a given application or environment. The computing system 400 may include one or more processors, such as a processor 402 that may be implemented using a general or special purpose processing engine such as, for example, a microprocessor, microcontroller or other control logic. In this example, the processor 402 is connected to a bus 404 or other communication medium. In some embodiments, the processor 402 may be an Artificial Intelligence (AI) processor, which may be implemented as a Tensor Processing Unit (TPU), or a graphical processor unit, or a custom programmable solution Field-Programmable Gate Array (FPGA).

The computing system 400 may also include a memory 406 (main memory), for example, Random Access Memory (RAM) or other dynamic memory, for storing information and instructions to be executed by the processor 402. The memory 406 also may be used for storing temporary variables or other intermediate information during execution of instructions to be executed by the processor 402. The computing system 400 may likewise include a read only memory (“ROM”) or other static storage device coupled to bus 404 for storing static information and instructions for the processor 402.

The computing system 400 may also include a storage devices 408, which may include, for example, a media drive 410 and a removable storage interface. The media drive 410 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 412 may include, for example, a hard disk, magnetic tape, flash drive, or other fixed or removable medium that is read by and written to by the media drive 410. As these examples illustrate, the storage media 412 may include a computer-readable storage medium having stored therein particular computer software or data.

In alternative embodiments, the storage devices 408 may include other similar instrumentalities for allowing computer programs or other instructions or data to be loaded into the computing system 400. Such instrumentalities may include, for example, a removable storage unit 414 and a storage unit interface 416, such as a program cartridge and cartridge interface, a removable memory (for example, a flash memory or other removable memory module) and memory slot, and other removable storage units and interfaces that allow software and data to be transferred from the removable storage unit 414 to the computing system 400.

The computing system 400 may also include a communications interface 418. The communications interface 418 may be used to allow software and data to be transferred between the computing system 400 and external devices. Examples of the communications interface 418 may include a network interface (such as an Ethernet or other NIC card), a communications port (such as for example, a USB port, a micro USB port), Near field Communication (NFC), etc. Software and data transferred via the communications interface 418 are in the form of signals which may be electronic, electromagnetic, optical, or other signals capable of being received by the communications interface 418. These signals are provided to the communications interface 418 via a channel 420. The channel 420 may carry signals and may be implemented using a wireless medium, wire or cable, fiber optics, or other communications medium. Some examples of the channel 420 may include a phone line, a cellular phone link, an RF link, a Bluetooth link, a network interface, a local or wide area network, and other communications channels.

The computing system 400 may further include Input/Output (I/O) devices 422. Examples may include, but are not limited to a display, keypad, microphone, audio speakers, vibrating motor, LED lights, etc. The I/O devices 422 may receive input from a user and also display an output of the computation performed by the processor 402. In this document, the terms “computer program product” and “computer-readable medium” may be used generally to refer to media such as, for example, the memory 406, the storage devices 408, the removable storage unit 414, or signal(s) on the channel 420. These and other forms of computer-readable media may be involved in providing one or more sequences of one or more instructions to the processor 402 for execution. Such instructions, generally referred to as “computer program code” (which may be grouped in the form of computer programs or other groupings), when executed, enable the computing system 400 to perform features or functions of embodiments of the present invention.

In an embodiment where the elements are implemented using software, the software may be stored in a computer-readable medium and loaded into the computing system 400 using, for example, the removable storage unit 414, the media drive 410 or the communications interface 418. The control logic (in this example, software instructions or computer program code), when executed by the processor 402, causes the processor 402 to perform the functions of the invention as described herein.

Various embodiments provide method and system for evaluating candidates through Artificial Intelligence (AI) models. The disclosed method and system may receive input data including video data and audio data corresponding to an interview of a candidate. It may be noted that video data may include a plurality of frames. Further, the method and system may extract in near real-time, a set of video features from each of the plurality of frames of video using a first self-learning AI model, and a set of audio features from the audio data using a second self-learning AI model. It should be noted that the set of video features and the set of audio features may correspond to a set of predefined parameters. Further, the method and system may compare the set of video features and the set of audio features with predefined threshold values corresponding to the set of predefined parameters. Further, the method and system may generate a score corresponding to each of the set of predefined parameters of the candidate using the first self-learning AI model and the second self-learning AI model based on the comparison.

Thus, the techniques described in the present disclosure try to overcome the technical problem of evaluating candidates through Artificial Intelligence (AI) models. The techniques provide for cost and time reduction of the evaluation procedure. The techniques further provide for standardization of organization's evaluation. The techniques remove human biasness (gender, age, race, color, etc.). The techniques further provide for balancing/reducing the weight given to individual opinions for non-core skill preferences. Further, the techniques provide for reducing travel and carbon footprint. Further, the techniques facilitate optimization of the time and bandwidth of the evaluators with an increased number of candidates.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for evaluating candidates through Artificial Intelligence (AI) models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for evaluating candidates through Artificial Intelligence (AI) models, the method comprising:
receiving, by a computing device, input data comprising video data and audio data corresponding to an interview of a candidate, wherein the video data comprises a plurality of frames;
extracting in near real-time, by the computing device,
a set of video features from each of the plurality of frames of the video data using a first self-learning AI model, and
a set of audio features from the audio data using a second self-learning AI model,
wherein the set of video features and the set of audio features correspond to a set of predefined parameters;
comparing, by the computing device, the set of video features and the set of audio features with self-adjusting threshold values corresponding to the set of predefined parameters; and
generating, by the computing device, a score corresponding to each of the set of predefined parameters of the candidate using the first self-learning AI model and the second self-learning AI model based on the comparison.

2. The method of claim 1, further comprising generating a report for the candidate, wherein the report comprises the set of predefined parameters and the score corresponding to each of the set of predefined parameters.

3. The method of claim 1, wherein the set of predefined parameters comprises soft skill attributes, communication skill attributes, body language attributes, and knowledge attributes.

4. The method of claim 1, wherein the second self-learning AI model is a Natural Language Processing (NLP) model.

5. The method of claim 1, further comprising receiving in real-time, the input data from a camera.

6. The method of claim 5, further comprising training the first self-learning AI model and the second self-learning AI model using the input data received in real-time.

7. The method of claim 1, further comprising:
extracting the video data from the input data; and
extracting the audio data from the input data.

8. The method of claim 1, further comprising:
storing the video data in a video repository; and
storing the audio data in an audio repository.

9. A system for evaluating candidates through Artificial Intelligence (AI) models, the system comprising:
a processor; and
a memory communicatively coupled to the processor, wherein the memory stores processor instructions, which when executed by the processor, cause the processor to:
receive input data comprising video data and audio data corresponding to an interview of a candidate, wherein the video data comprises a plurality of frames;
extract in near real-time,
a set of video features from each of the plurality of frames of the video data using a first self-learning AI model, and
a set of audio features from the audio data using a second self-learning AI model,
wherein the set of video features and the set of audio features correspond to a set of predefined parameters;
compare the set of video features and the set of audio features with self-adjusting threshold values corresponding to the set of predefined parameters; and
generate a score corresponding to each of the set of predefined parameters of the candidate using the first self-learning AI model and the second self-learning AI model based on the comparison.

10. The system of claim 9, wherein the processor instructions, on execution, further cause the processor to generate a report for the candidate, wherein the report comprises the set of predefined parameters and the score corresponding to each of the set of predefined parameters.

11. The system of claim 9, wherein the set of predefined parameters comprises soft skill attributes, communication skill attributes, body language attributes, and knowledge attributes.

12. The system of claim 9, wherein the second self-learning AI model is a Natural Language Processing (NLP) model.

13. The system of claim 9, wherein the processor instructions, on execution, further cause the processor to receive in real-time, the input data from a camera.

14. The system of claim 13, wherein the processor instructions, on execution, further cause the processor to train the first self-learning AI model and the second self-learning AI model using the input data received in real time.

15. The system of claim 9, wherein the processor instructions, on execution, further cause the processor to:
extract the video data from the input data; and
extract the audio data from the input data.

16. The system of claim 9, wherein the processor instructions, on execution, further cause the processor to:
store the video data in a video repository; and
store the audio data in an audio repository.

17. A non-transitory computer-readable medium storing computer-executable instructions for evaluating candidates through Artificial Intelligence (AI) models, the computer-executable instructions configured for:
receiving input data comprising video data and audio data corresponding to an interview of a candidate, wherein the video data comprises a plurality of frames;
extracting in near real-time,
a set of video features from each of the plurality of frames of the video data using a first self-learning AI model, and
a set of audio features from the audio data using a second self-learning AI model,
wherein the set of video features and the set of audio features correspond to a set of predefined parameters;
comparing the set of video features and the set of audio features with self-adjusting threshold values corresponding to the set of predefined parameters; and
generating a score corresponding to each of the set of predefined parameters of the candidate using the first self-learning AI model and the second self-learning AI model based on the comparison.

18. The non-transitory computer-readable medium of claim 17, wherein the computer-executable instructions are further configured for generating a report for the candidate, wherein the report comprises the set of predefined parameters and the score corresponding to each of the set of predefined parameters.

19. The non-transitory computer-readable medium of claim 17, wherein the set of predefined parameters comprises soft skill attributes, communication skill attributes, body language attributes, and knowledge attributes.

20. The non-transitory computer-readable medium of claim 17, wherein the second self-learning AI model is a Natural Language Processing (NLP) model.
